(19) United States
(12) Patent Application Publication
(10) Pub. No.: US 2019/0172456 A1
(43) Pub. Date: Jun. 6, 2019

(54) METHOD FOR SHARING PHOTOGRAPH BASED ON VOICE RECOGNITION, APPARATUS AND SYSTEM FOR THE SAME

(71) Applicant: LIVE PICTURES CO.,LTD., Ulsan (KR)

(72) Inventor: SEOK-HEE LEE, Busan (KR)

(21) Appl. No.: 16/191,342

(22) Filed: Nov. 14, 2018

(30) Foreign Application Priority Data
Dec. 5, 2017 (KR) 10-2017-0165720
Aug. 10, 2018 (KR) 10-2018-0093553

(51) Int. Cl. G10L 15/22; G06T 7/70; G06T 11/60; G10L 15/18; G10L 15/30

(52) U.S. Cl. CPC G10L 15/22; G06T 7/70; G10L 15/30; G10L 15/1815; G06T 11/60

(57) ABSTRACT

Provided is a method for sharing a photograph based on voice recognition in an aspect. The method may include obtaining an image for a photograph taken using a camera; obtaining voice data associated with the obtained image; generating a text by recognizing the obtained voice data; associating and storing the obtained image, the obtained voice data and the generated text; and outputting the store image together with at least one of the stored voice data and the stored text.

### CROSS-REFERENCE TO RELATED APPLICATIONS

This application claims the benefit of priorities of Korean Patent Application No. 10-2017-0165720 filed on Dec. 5, 2017 and Korean Patent Application No. 10-2018-0093553 filed on Aug. 10, 2018, all of which are incorporated by reference in their entirety herein.

### BACKGROUND OF THE INVENTION

### Field of the invention

The present invention relates to a method for sharing a photograph and, more particularly, to a method for sharing photograph contents while a plurality of users feels enjoyable experiences by adding fun factors and convenience factors to the photograph contents.

### Related Art

The conventional analog camera records an image taken using light, and after going through the process of developing and printing the image, a user may see the taken image.

However, recently, with the development of electronics technique, particularly, optics techniques, a large number of new types of digital cameras have been emerged. Moreover, the capacities of cameras mounted on Smartphone, as well as the conventional cameras, have been greatly improved into a new concept.

Accordingly, the camera of Smartphone or the digital camera may not require the complex processes of developing and printing an image after taking a photograph, but may store the taken image in digital storage medium embedded in the camera or the Smartphone, and consequently, a user may check the taken image easily by outputting the image using the monitor mounted on the camera or the Smartphone. In addition, the digital camera may substitute the role of the conventional camera and the scanner, and has an advantage of editing and modifying an image easily since it has high compatibility with image data of a PC. However, such a digital camera has a problem that various memories of detailed situation and atmosphere in which an image is taken as well as a still image of taken place, feeling when the image was taken and an accompany on the timing of taking the image should be recorded by only the taken image.

Smartphone has been developed in various functionalities, and particularly, the functions are improved such as resolution of an image, editing of an image, and the like when a photograph or a video is taken in accordance with the needs of a user. However, the Smartphone has still the same problem of the conventional phone or the digital camera.

In order to improve such a problem, techniques of inputting additional information has been developed, such as a text in the photographed image by using a camera or a Smartphone. The information input system of an image of Patent Registration No. 10-1053045 discloses the technique of inputting text, voice or image information provided from a user or a user terminal into a photograph or a video image stored in an imaging device including a camera in wired/wireless manner.

However, the information input system of an image has to input the text, voice or image information provided from a user or a user terminal separately in wired/wireless manner, which increases a cost, and has a restriction in a linkage method with the text, voice and new image provided with the photograph which is already generated.

According to the method and apparatus for adding a note on image contents with metadata generated by using voice recognition technique disclosed in Patent Registration No. 10-1115701, image contents are rendered on a display device, a voice segment is received from a user and the voice segment annotates on a part of the image contents currently rendered, the voice segment is transformed into text segment, and the text segment is associated with the rendered part of the image contents. The text segment is stored in a selectively searchable manner, and associated with the rendered part of the image contents.

Such a conventional art proposes a technique of recognizing a voice with voice recognition, and adding the recognized voice into a digital photograph by transforming the voice into string text. However, according to the technique, the recognized voice is simply transformed to text and added to a photograph, and accordingly, there is a problem that voice recognition error occurs in a situation that a plurality of users makes voices and the proper function cannot be performed.

### SUMMARY OF THE INVENTION

The present invention provides a method, apparatus and system for sharing a photograph based on voice recognition that generates a text using voice recognition, inserts an image into the generated text, and outputs the text and/or the voice with the image.

The present invention also provides a method, apparatus and system for sharing a photograph using a block-chain.

In an aspect, a method for sharing a photograph based on voice recognition may include obtaining an image for a photograph taken using a camera, obtaining voice data associated with the obtained image, generating a text by recognizing the obtained voice data, associating and storing the obtained image, the obtained voice data and the generated text and outputting the store image together with at least one of the stored voice data and the stored text.

The obtained image may be obtained from at least one of a currently taken photograph and a previously stored photograph taken on a time before the present time.

The associating and storing the obtained image, the obtained voice data and the generated text may include storing the obtained image, the obtained voice data and the generated text in a server.

The associating and storing the obtained image, the obtained voice data and the generated text may include inserting the text into the image, and the text is inserted to a first layer which is identical to a layer which the image is inserted in or inserted into a second layer which is different from the layer which the image is inserted in.

The insertion of the text into the first layer may include inserting the text into an arbitrary area on the image, identifying a first area in which the text is inserted and generating the image in which the text is inserted as an image file, and the image file is associated with identification information on the first area.

The generating the image in which the text is inserted into an image file may include scanning the image in which the text is inserted and generate it as an image file.

When the text is inserted to the first layer, the stored voice data may be played back in response to a user input for the identified first area.

When the text is inserted to the second layer, the stored voice data may be played back in response to a user input for the text of the second layer.

The stored voice data may be stored by being packaged with the image and the text.

The stored voice data may be stored in a separate storage, and the image and the text may be packaged with link information on the storage of the voice data.

The associated voice data may include at least one of voice data associated with a photographer placed outside of a first space in relation to taking the photograph and voice data associated with a subject placed in the first space.

The associating and storing the obtained image, the obtained voice data and the generated text may include analyzing voice of the obtained voice data, wherein the voice data includes a first voice data having a first voice characteristic and a second voice data having a second voice characteristic, and separating into the first voice data and the second voice data.

The method may include generating a first text by recognizing the separated first voice data and generating a second text by recognizing the separated second voice data, and the first text and the second text are associated with the first voice data and the second voice data, respectively.

The first text may be disposed on a position on the stored image according to a first input of a user, and the second text may be disposed on a position on the stored image according to a second input of a user.

The associating and storing the obtained image, the obtained voice data and the generated text may include recognizing each of a first subject and a second subject included in the image by applying object recognition algorithm for the image, associating the first subject included in the image with the first text and associating the second subject included in the image with the second text.

The first text may be disposed around the first subject and the second text may be disposed around the second subject.

The associating and storing the obtained image, the obtained voice data and the generated text may include identifying the voice data by comparing voice characteristic information associated with the obtained voice data with voice characteristic information previously stored in a voice database.

A position of the text may be determined by at least one of: a first mode in which the text is automatically disposed in at least one position of a previously designated position and a position according to an image analysis result, among the area of the image or a second mode in which the text is disposed according to a user input.

The method for sharing a photograph based on voice recognition may further include analyzing a meaning of the text, and the text is automatically disposed in an area corresponding to meaning analysis result when operating in the first mode.

The text having a first meaning may be disposed on an area associated with the subject in the image, and the text having a second meaning may be disposed on a predetermined area among the entire area of the image without regard to the subject.

When the stored image is registered in Social Network Service (SNS), the stored image may be registered by generating hash tag automatically based on at least one of the image, the voice data, the text and metadata associated with the image.

When the stored image is registered in the Social Network Service (SNS), the stored image may be registered by generating hash tag automatically based on the information on a first object by extracting the first object in the image.

When outputting the text, based on an output order among a plurality of letters that construct the text, an output order among a plurality of strokes included in each of the plurality of letters and information on drawing from an output start point to an output end point of each of the plurality of strokes, the text may be outputted with a dictation format from a first letter to a last letter of the text.

The associating and storing the obtained image, the obtained voice data and the generated text may include storing the information associated with the obtained image, the obtained voice data and the generated text in block-chain.

When there is a request for recording the information associated with the obtained image, the obtained voice data and the generated text in block-chain format, the user terminal may generate a public key and a private key through an authentication information issuance server and transmits it to the blockchain-based data management server, and may provide the information associated with the obtained image, the obtained voice data and the generated text to the blockchain data possession server.

The public key and the private key may be used for checking whether the public key and the private key is registered in the blockchain-based data management server, the information associated with the obtained image, the obtained voice data and the generated text is processed into a hash value and generated as transaction for recoding information, and the generated transaction is forwarded to the block-chain data possession servers to be approved.

In another aspect, an apparatus for sharing a photograph based on voice recognition may include an information acquisition unit for obtaining an image for a photograph taken using a camera, and obtaining voice data associated with the obtained image, a text transform unit for generating a text by recognizing the obtained voice data, a data storage unit for associating and storing the obtained image, the obtained voice data and the generated text and a data output unit for outputting the store image together with at least one of the stored voice data and the stored text.

In another aspect, a system for sharing a photograph based on voice recognition may include a user terminal for obtaining an image associated with a photograph and voice data associated with the image, generating a text by recognizing the obtained voice data, associating and storing the image, the voice data and the text, and requesting to record the stored image, the voice data and the text in block-chain format, a plurality of block-chain possession servers for recording the image, the voice data and the text generated in the user terminal in the block-chain format, and a blockchain-based data management server for processing a block-chain management role including at least one of addition, move and deletion for block-chain information recorded in the block-chain data possession servers based on an approval of the block-chain data possession servers.

The blockchain-based data management server may record at least one of download information and payment information in relation to the image, the voice data and the text, which are exchanged between a first user terminal and a second user terminal, in the block-chain data possession servers.

When there is a request of recording the block-chain of the image, the voice data and the text, wherein the user terminal generates a public key and a private key through an authentication information issuance server and transmits it to the blockchain-based data management server, after checking whether the public key and the private key received from the user terminal is registered, the blockchain-based data management server may generate the transaction for recording information by processing the image, the voice data and the text requested by the user terminal into hash value, and forwards the generated transaction to the block-chain data possession servers to be approved.

### BRIEF DESCRIPTION OF THE DRAWINGS

FIG. 1 is a schematic diagram for schematically describing a method for sharing a photograph based on voice recognition according to an embodiment of the present invention.

FIG. 2 is a block diagram schematically illustrating a photograph sharing apparatus based on voice recognition according to an embodiment of the present invention.

FIG. 3 is a flowchart schematically illustrating a method of inserting a voice into an image by distinguishing a photographer's voice and a subject's voice of the photograph sharing method based on voice recognition according to an embodiment of the present invention.

FIGS. 4a and 4b are schematic diagrams for describing a scheme that a text is inserted into an image.

FIGS. 5a and 5b are schematic diagrams for describing a method for storing image, text and voice as an example.

FIG. 6 is a block diagram illustrating a configuration that the voice-recognized text data is inserted in an image with being associated with a subject.

FIG. 7 is a schematic diagram for describing a method for matching voice data having different voice characteristic to a specific subject in an image.

FIGS. 8a and 8b are schematic diagram for describing the process that the text is disposed on an arbitrary position in the image according to the automatic mode and the manual mode.

FIG. 9 is a block diagram particularly illustrating a configuration for determining an insertion position according to a meaning of a recognized text.

FIG. 10 is a schematic diagram for describing automatic generation of a hash tag.

FIG. 11 is a schematic diagram for describing an emotional text drawing.

FIG. 12 is a block diagram illustrating a system for storing data based on block-chain according to an embodiment of the present invention.

FIG. 13 is a flowchart for describing a method for storing data based on block-chain according to an embodiment of the present invention.

### DESCRIPTION OF EXEMPLARY EMBODIMENTS

While the present invention is capable of being variously modified and altered, specific embodiments thereof are shown by way of example in the drawings and will herein be described in detail.

It is to be understood, however, that the present invention is not to be limited to the specific embodiments, but includes all modifications, equivalents, and alternatives falling within the spirit and scope of the invention.

Terms such as first, second, and the like may be used to describe various components, but the components should not be limited by these terms. The terms are used only for the purpose of distinguishing one component from another. For example, without departing from the scope of the present invention, the first component may be referred to as a second component, and similarly, the second component may also be referred to as a first component.

The term “and/or” includes any combination of a plurality of related listed items or any of a plurality of related listed items.

It is to be understood that when an element is referred to as being “connected” or “coupled” to another element, it may be directly connected or coupled to the other component, but it should be understood that other components may be present between them. On the other hand, when an element is referred to as being “directly connected” or “directly coupled” to another element, it should be understood that there are no other elements between them.

The terminology used herein is for the purpose of describing particular embodiments only and is not intended to be limiting of the present invention. The singular forms include plural referents unless the context clearly dictates otherwise. In this application, the terms “includes” or “having”, etc., are used to specify that there is a stated feature, figure, step, operation, element, part or combination thereof, but do not preclude the presence or addition of one or more other features, integers, steps, operations, components, parts, or combinations thereof.

Unless defined otherwise, all terms used herein, including technical or scientific terms, have the same meaning as commonly understood by one of ordinary skill in the art to which this invention belongs. Terms such as those defined in commonly used dictionaries should be interpreted as having a meaning consistent with the contextual meaning of the related art and should not be interpreted as either ideal or overly formal in meaning unless explicitly defined in the present application.

Hereinafter, the preferred embodiments of the present invention will be described in more detail with reference to the accompanying drawings. In order to facilitate the general understanding of the present invention in describing the present invention, through the accompanying drawings, the same reference numerals will be used to describe the same components and an overlapped description of the same components will be omitted.

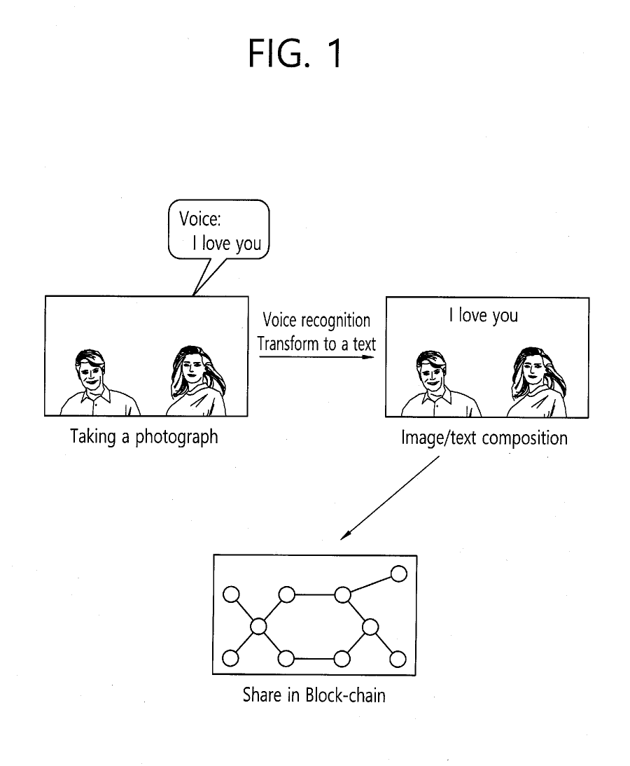

FIG. 1 is a schematic diagram for schematically describing a method for sharing a photograph based on voice recognition according to an embodiment of the present invention.

Referring to the top left part of FIG. 1, a photograph sharing apparatus according to an embodiment of the present invention includes a photographing means such as a camera. The apparatus may obtain image information through photographing an image. The apparatus includes a voice acquisition means such as a microphone. The apparatus may obtain data associated with the voice generated when taking a photograph, recognize the obtained voice data using at least one voice recognition algorithm, and transform the recognized information into a text. The data associated with voice may include a voice input when a previously stored photograph is loaded after taking the photograph. After voice recognition, the voice data is not discarded, but stored with being associated with image and text information. For example, when a user input is generated, such as, click or touch on the generated text, or the like, a matching relation between the image and the text, between the text and the voice, and/or between the image and the voice is defined such that the voice stored associated with the text is played back. However, the voice is not necessarily played back only when the text is clicked. But rather, when an area of the image is clicked, the voice may be played back.

Referring to the top right part of FIG. 1, the transformed text is inserted in an area of the image. The position in which the text is inserted may be determined manually by a user input, but may also be disposed on an area automatically. Particularly, the position may be disposed, through an analysis of meaning of the voice-recognized text, and on the position associated with the analysis of meaning result. For example, an insertion position of text for an expression having a meaning that interconnects two or more subjects like “I love you” may be predefined such that the position of the expression is disposed between two subjects. Alternatively, in the case that a word representing a name of a person like “xx” or “yy” is associated with the image including a subject, the word may be disposed near to the corresponding subject. That is, based on at least one of the analysis of meaning result and the number of subjects in the image, relationship between subjects, or object analysis result (including association information on whether it is an object or a person) of the subjects, the position of the text may be determined. As such, when the image and the text are composited, the associated image may be output together with the text and/or the voice. For example, when the photograph is clicked, the voice may be played back. This is the same for the case that the photograph is downloaded from other terminal.

In addition, Referring to the bottom part of FIG. 1, the apparatus may store an image, text and voice data by packaging it. In this case, the image, text and voice data may be stored in a typical Social Network Service (SNS) like an interne café and/or a block-chain and shared with multiple users. The data shared through a shared channel using such a method may be searched based on the metadata (e.g., the date and time, the place of photograph, photographing device information, etc.) associated with the image, the voice data and/or the text data. For example, the image including the corresponding text may be searched through the text generated based on the voice recognition such as “I love you” as well as based on the photographing place like “Seoul”.

According to an embodiment of the present invention, the apparatus includes a device in which a communication is available while taking a photograph and a voice acquisition are also available such as a camera and a micro phone. In addition, the apparatus includes a device that may obtain voice-recognized information by executing voice recognition algorithm directly or external voice recognition algorithm. The apparatus according to an embodiment of the present invention may be referred to as a Mobile Station (MS), a User Equipment (UE), a User Terminal (UT), a Wireless Terminal, an Access Terminal (AT), a Terminal, a fixed or mobile Subscriber Unit, a Subscriber Station (SS), a cellular phone, a wireless device, a wireless communication device, a Wireless Transmit/Receive Unit (WTRU), a mobile node, a mobile station, a personal digital assistant (PDA), a Smartphone, a laptop, a net book, a personal computer, a wireless sensor, a Customer Equipment (CE), or other terms. The various embodiments of the apparatus may include a cellular phone, a Smartphone equipped with wireless communication function, a personal digital assistant (PDA) equipped with wireless communication function, a personal computer equipped with wireless communication function, a photographing device like a digital camera equipped with wireless communication function, a gaming device equipped with wireless communication function, an image/music storage and playback electronic device equipped with wireless communication function, and an internet electronic device in which wireless internet access and browsing are available, and also a portable unit or terminals in which such functions are integrated, but not limited thereto.

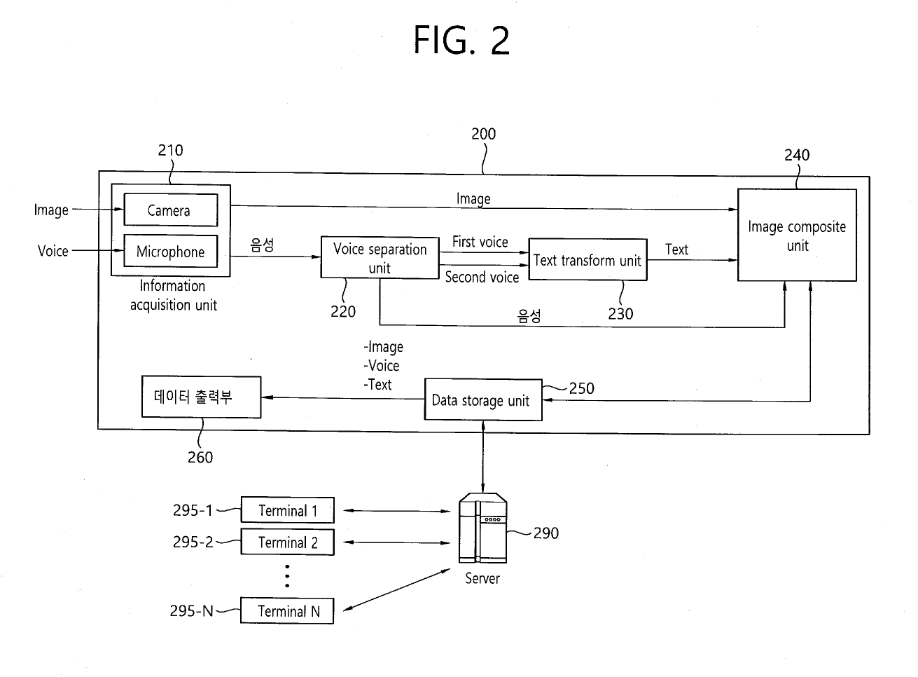

FIG. 2 is a block diagram schematically illustrating a photograph sharing apparatus based on voice recognition according to an embodiment of the present invention. As shown in FIG. 2, the photograph sharing apparatus 200 according to an embodiment of the present invention may include an information acquisition unit 210, a voice separation unit 220, a text transform unit 230, an image composite unit 240, a data storage unit 250 and a data output unit 260.

Each of the elements may be implemented as hardware embedded on the apparatus. The voice separation unit 220, the text transform unit 230, and the image composite unit 240 may be implemented with a single microprocessor performing each function or a combination of two or more microprocessors and the microprocessor execute a command for performing each function. The command may be stored in a memory (not shown).

Referring to FIG. 2, the information acquisition unit 210 may include a camera and a microphone. The information acquisition unit 210 may operate the camera by executing a photographing application. The camera obtains an image by photographing a subject. The camera may generate and provide optical related information. This may be used for calculating a distance from the subject. The information acquisition unit 210 may obtain an image by loading a previously stored image from a local storage (not shown). At this time, a voice associated with the previously stored image may exist, and otherwise, but a file in which only an image is stored may be loaded. The information acquisition unit 210 may obtain the voice input from a user through the microphone when a file is loaded by a user input, and may receive an input of the previously stored image and a currently input voice. The microphone is a component for obtaining a voice signal. The camera and the microphone may be embedded in the apparatus or may be provided with being connected through a separate interface. The image among the obtained information from the information acquisition unit 210 may be provided to the image composite unit 240, and the voice data may be provided to the voice separation unit 220.

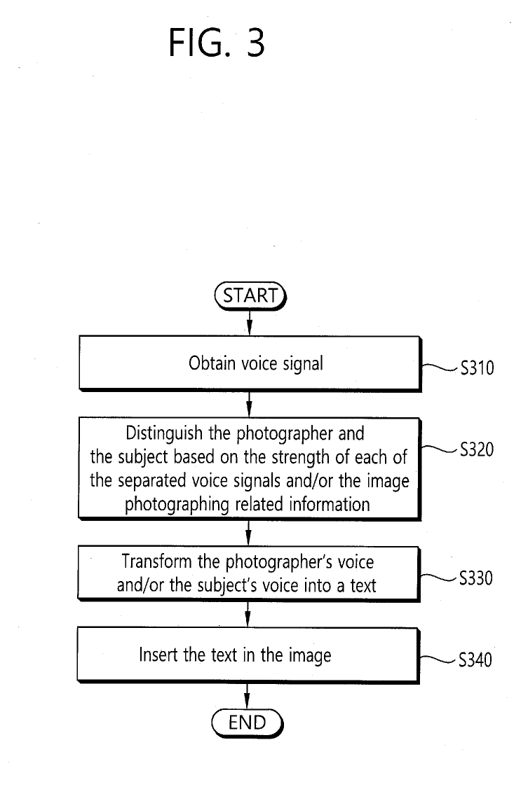

The voice separation unit 220 analyzes the voice obtained through the microphone and separates it into at least one voice signal. First, the voice separation unit 220 filters a voice of a person through a filter (not shown). Since the voice signal input may have a plurality of noises, the noises are filtered, and only a voice of a person is extracted. In addition, at least one voice signal of a person is generated by using a frequency of the voice and strength of the voice from the extracted voice signal of the person. The voice separation unit 220 analyzes the frequency component included in a primary filtered signal and obtains voice characteristic information. A waveform fluctuation of the voice signal is serious, but waveform fluctuation of the type of frequency spectrum is small and it is easy to extract the information such as formant that characterizes the voice. Particularly, in the case that multiple frequency components are mixed, the voice separation unit 220 analyzes this, and extracts individual frequency component, and then, generates multiple voice signals. For example, in the case that two signals of which voice properties are different are mixed, a first voice signal and a second voice signal are separated and provided to the text transform unit 230. In addition, additional voice signal analysis is performed and compared with associated voice signal database (not shown), and then a voice signal matched to the previously stored voice signal property may be extracted. The matched voice signal may include identification information. Such an additional voice signal analysis may also be performed in the image composite unit 240. The voice analysis result performed in the voice separation unit 220 is provided to the image composite unit 240. The voice separation unit 220 may separate the voice of the subject included in a photograph area from the other voice (e.g., a third party, such as a photographer, etc.) when the photograph is taken. This is described in more detail with reference to FIG. 3 below.

FIG. 3 is a flowchart schematically illustrating a method of inserting a voice into an image by distinguishing a photographer's voice and a subject's voice of the photograph sharing method based on voice recognition according to an embodiment of the present invention.

Referring to FIG. 3, voice separation unit may separate a plurality of voice signals through the frequency components included in the voice signals, as described above, and may obtain the information associated with the separated voice signal (S310). In the case that there is a voice signal of only one person, the voice separation may not be required. Then, the apparatus may distinguish the photographer and the subject based on the strength of each of the separated voice signals and/or the image photographing-related information (S320). The apparatus may determine the distance from the seperated voice signal through the strength of the voice signal and other voice characteristic information. In addition, the image photographing-related information may include a size of the subject and zoom-in/zoom-out information on the camera. Through this, it may be determined the degree of zoom-in or zoom-out the subject by an optical system of the camera, and it may be identified the distance from the subject by analyzing the optical information and a size of the subject. A first distance calculated based on each of the voice signals separated through the process above and the size analysis result of the subject and/or a second distance calculated based on the optical information on the camera are compared, and it is determined the first distance is included in a predetermined area (the area may be defined based on the preconfigured a first reference value) from the second distance to the subject, and accordingly, it is determined whether the voice is the subject's voice or not. In addition, through the determination whether the first distance is within a second reference value from the apparatus, the voice of the photographer input from a neighboring position may be distinguished. In the case that the voice is neither the voice of the photographer nor the voice of the subject, the voice is treated as noise or it may be controlled that the voice is treated differently through separate algorithm.

Through the process, when the voice is distinguished from the photographer's and/or the subject's, each voice may be transformed into a text in the text transform unit (S330). At this time, identification information (or may be referred to “association information” for representing interrelationship with the voice signal) for distinguishing it is the text according to the voice of the photographer and/or the text according to the voice of the subject may be added to the transformed text. And, each text to which the identification information is added may be inserted to the image (S340). At this time, each text may be differently treated based on the identification information, and inserted to the image. For example, it is controlled that the photographer text is inserted in the center of the entire area of the image, and the text of the subject is inserted in the periphery of the subject of the image. Otherwise, the editing method may be changed.

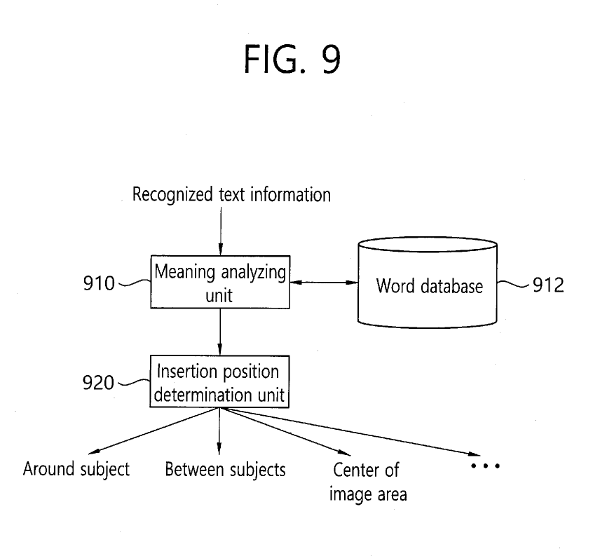

Referring to FIG. 2 again, the text transform unit 230 transforms at least one voice signal separated in the voice separation unit 220 into text, respectively. In the case that the voice is separated into two voice signals, a first voice signal is transformed into a first text, and a second voice signal is transformed into a second text. In this case, the first voice signal may be that of the photographer and the second voice signal may be that of the subject. Otherwise, the first voice signal may be that of a first subject and the second voice signal may be that of a second subject. The text transform unit 230 transforms the separated voice signals into text using voice recognition algorithm. The voice recognition algorithm according to an embodiment of the present invention includes the algorithm for distinguishing linguistic meaning contents from each of the voice signals separated in the voice separation unit 220. More particularly, the algorithm includes the process of distinguishing a word or a string by analyzing voice waveform and extracting the meaning, and this includes the process of voice analysis, phonemic awareness, word awareness, sentence interpretation and meaning extraction. The text transform unit 230 that processes the voice recognition algorithm may implement voice recognition means and voice composite means with a few millimeter-size integrated circuits using large scale integrated circuit (LSI). The voice recognition algorithm according to an embodiment of the present invention may be interlinked with meaning analysis algorithm in order to implement full speech-to-text conversion by natural vocalization. This means that it is associated with the speech understanding system that extracts the continuous voice or the contents of a sentence accurately using the information, knowledge, and the like in relation to the syntax information (grammar), meaning information as well as recognition of a word. This will be described in more detail with reference to FIG. 9 below.

The voice recognition algorithm according to an embodiment of the present invention described above may be executed within the apparatus. And in some cases, the text transform unit 230 provides the separated voice signals to a server 290 or a separate device, and the voice recognition is performed in the server 290 or the separate device, and then, the voice-recognized text information may be obtained. The text transform unit 230 may provide identification information to the text information transformed through each of the separated voice signals, and may identify the text to be matched to the voice signal.

The image composite unit 240 composes and/or integrates the image photographed through the camera with the text information transformed in the text transform unit 230. At this time, the base image of the composition may include the previously stored image or the image received and obtained from other apparatus as well as the currently photographing image, as described above. The image composite unit 240 composes the image with the text transformed in the text transform unit 230, and generates it into a single file. At this time, there are various methods of inserting the text into the image. The text may be distinguished, that is, whether the text is a text associated with the subject or the text associated with the photographer through the analysis of voice signal. And according to the distinguishing, the text may be inserted into different positions. In addition, in the case of the image including a plurality of subjects, the text associated with different subjects may be disposed near to the associated subject.

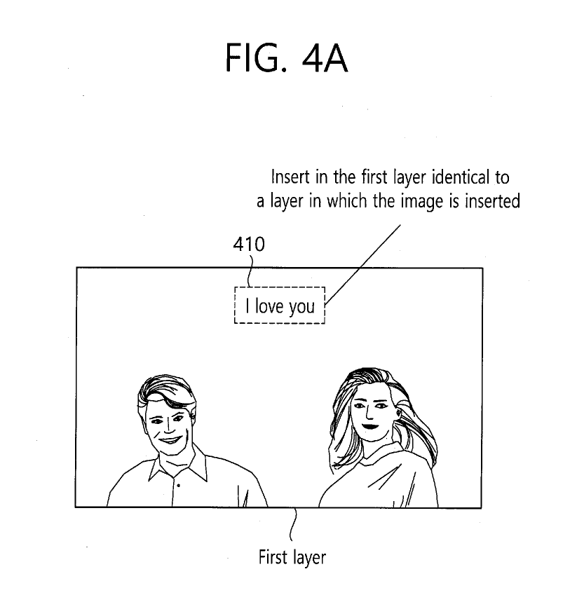

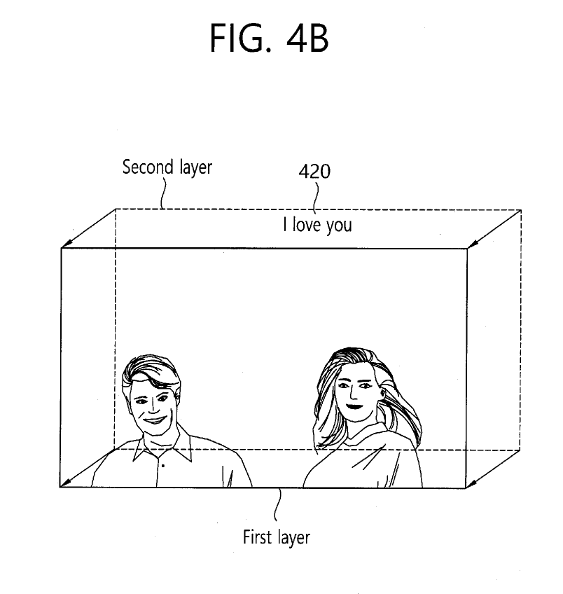

FIGS. 4a and 4b are schematic diagrams for describing a scheme that a text is inserted into an image.

Referring to FIG. 4a, the apparatus may insert an image and a text in the form that the text is inserted into the same layer as the image. At this time, the image may include at least one of a file of PNG, JPG, PDF, GIF and/or TIFF format. However, the image is not limited to the file of the format necessarily. The image composite unit 240 may transform a file format into the format proper to composition with the text. In addition, the text inserted herein may be inserted in a first layer which is the same as a layer which the image is inserted in. The image composite unit 240 may generate a text in an image format, and insert the text of the image format into the same layer. Alternatively, after disposing the text on the image by making the most of the text property, the image composite unit 240 may image the text through scanning, and may generate it into the image of the same layer. The image generated as such may be generated as a file such as JPG, PNG, PDF, and the like as a file of single format. At this time, the area information in which the imaged text is disposed may be generated, and the text may respond to a user input for the corresponding area. The response of the text may be a scheme of playing back by loading the associated voice information. For example, in the case that a user input is positioned on the area 410 on which “I love you” is placed, the user input on the area 410 is detected, and the voice associated with the text may be played back.

Referring to FIG. 4b, when it is assumed that the layer in which the image file is placed is the first layer, the image composite unit 240 may insert the text into a second layer, which is different from the first layer, and the image and the text are composed in the form of the first layer and the second layer being overlapped. Accordingly, the second layer in which the text is placed may be controlled independently from the first layer, and the disposed area 420 of the text of the second layer may independently respond to a user input. That is, the user input for the coordinate of the area 420 in which the text is actually disposed is detected, and it may respond such that the voice associated with the text is played back.

Additionally, the image and the text generated as such may be separately stored. When the image and the text are separately stored, the image and the text may be separately stored in the same format (e.g., PNG format) or may be separately stored in different formats (e.g., PNG and JPG formats).

According to an embodiment of the present invention, the text may be edited into various fonts, colors, sizes, and the like by a user configuration, and inserted. Particularly, the text may be inserted with different fonts, colors and sizes through association information with the subject and/or the photographer. For example, the text associated with the subject may be inserted in Gungseo font with size of 12, and the text associated with the photographer may be inserted in Gothic font with size of 15.

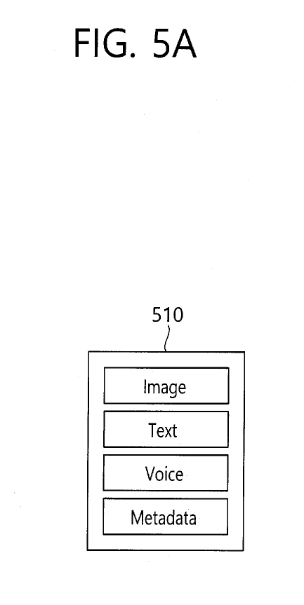

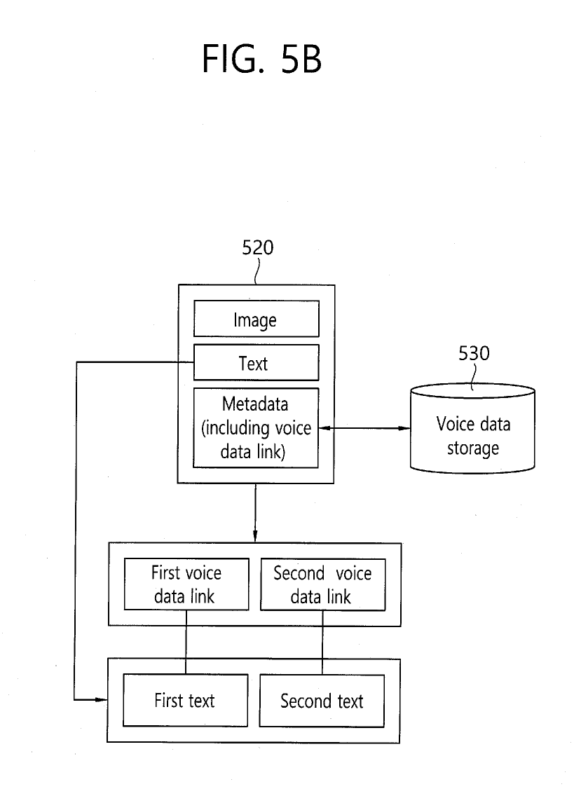

Referring to FIG. 2 again, the data storage unit 250 stores image, voice and text information. As described above, the image and the text may be stored as a single image or stored as a separated form. The parts in relation to storing the data will be described in more detail with reference to FIG. 5a and FIG. 5b.

FIGS. 5a and 5b are schematic diagrams for describing a method for storing image, text and voice as an example.

Referring to FIG. 5a, the data storage unit may packaging the image, text, voice and metadata and may store it as a file 510. At this time, the voice may include a plurality of voice data, and a plurality of the voice data of which voice characteristics are different may be separately stored. The metadata may include the date and time of photograph, the photographing place, photographing device and photographing application information.

As described with reference to FIG. 4a and FIG. 4b above, according to an embodiment of the present invention, the image and the text may be stored as an image file, or stored in different files. Accordingly, the image and the text may be played back once as a file or sequentially played back with different files. However, even in the case that the image and the text are stored in a file, the information associated with the text may be separately recorded as metadata. For example, in the recorded information, the text contents and the association information indicating the voice associated with the text may be stored as metadata. And based on the recorded information, search and hash tag generation may be performed.

Referring to FIG. 5b, the data storage unit may packaging the image, text and metadata and may store it as a file 520, and the voice data may be stored in a separate storage 530 (local storage and/or database of a server outside the apparatus), and may store the link information to the voice data in the metadata.

The text information may include a plurality of texts matched to a plurality of separated voice data. In the embodiment of FIG. 5b, the text includes a first text and a second text, and these are matched to the link information for a first voice data and the link information on a second voice data. Through such a storage scheme, in response to a user input for the first text, the link information on the first voice data is drawn, and based on the drawn link information, the storage 530 in which the voice information is stored is found and the corresponding voice may be played back. Since only the link information on the voice data is packaged, the weight of the packaged file is lighter than that of the embodiment of FIG. 5a.

Referring to FIG. 2 again, the data storage unit 250 may store the image, text and voice data in the apparatus, and the stored data may be shared with the server 290. The server 290 may include a server that manages SNS. The image, text and/or voice package data stored according to an embodiment of the present invention may be shared with other terminals 295-1 to 295-N using a specific web page on an internet. The apparatus 200 may upload the data stored in the specific web page using the server 290, and provide the uploaded data to the terminals 295-1 to 295-N that visit the corresponding web page. The terminals 295-1 to 295-N may output the text included in the image of the data uploaded through a user input and/or the associated voice. On the contrary, the text included in the image of data uploaded from the terminals 295-1 to 295-N and/or the associated voice information is received, and stored in the data storage unit 250.

The data output unit 260 may include a display means such as a monitor, a touch panel and a TV screen and a sound output means such as a speaker and an earphone. The data output unit 260 outputs the image, the image and the text and/or the associated voice information. The data output unit 260 may output an image file stored in response to a user input through a user interface (not shown) such as a touch screen, a mouse, a keyboard, and the like, and in this case, the text may be output with being included in the image. In addition, when there is a user input for the image and/or the text, the associated voice data is played back by using the association information with the text.

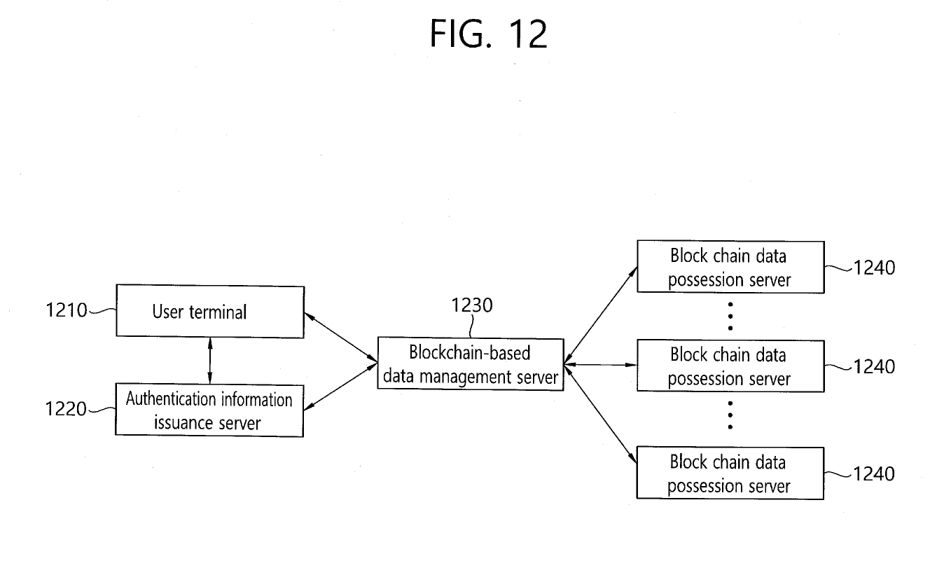

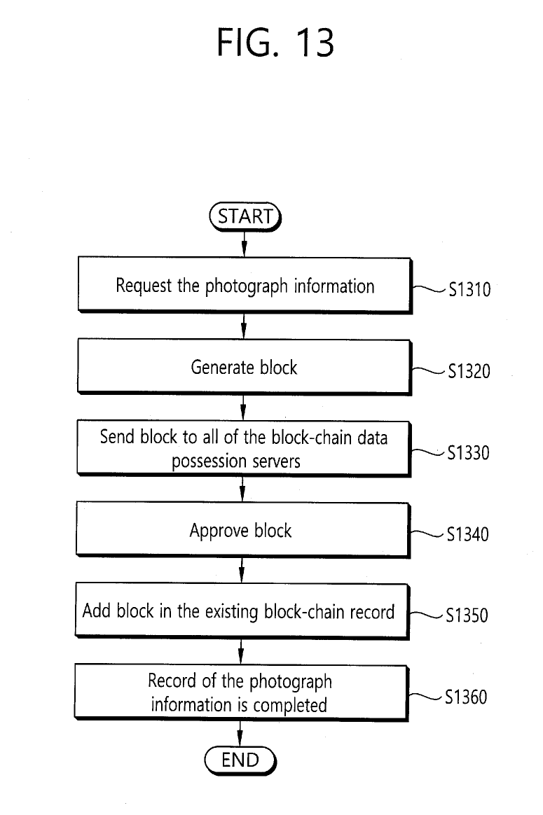

According to another embodiment of the present invention, the server 290 includes a server associated with block-chain. At this time, the server 290 may operate as a server for managing the block-chain, and each of the terminals 295-1 to 295-N may operate as a server including block-chain. This will be described in more detail with reference to FIG. 12 and FIG. 13 below.

When receiving the image, text and/or voice data from a plurality of terminals 295-1 to 295-N, the server 290 may store it, and may return the data that the terminals 295-1 to 295-N want. At this time, a search through the text and/or the voice data as well as the image may be performed. Particularly, the search through the text and the voice data is more useful than the search through a general search word since data for advertisement may be excluded. That is, the search for the text and the voice data items is performed, and only the image in which the corresponding search word is included as the text and the voice data may be searched. The selection of the item may be performed in various manners with an object or metadata (the date and time of photograph, the place, etc.) in the image as well as the text and the voice, and through this, the search for the stored data may be performed in more compact manner.

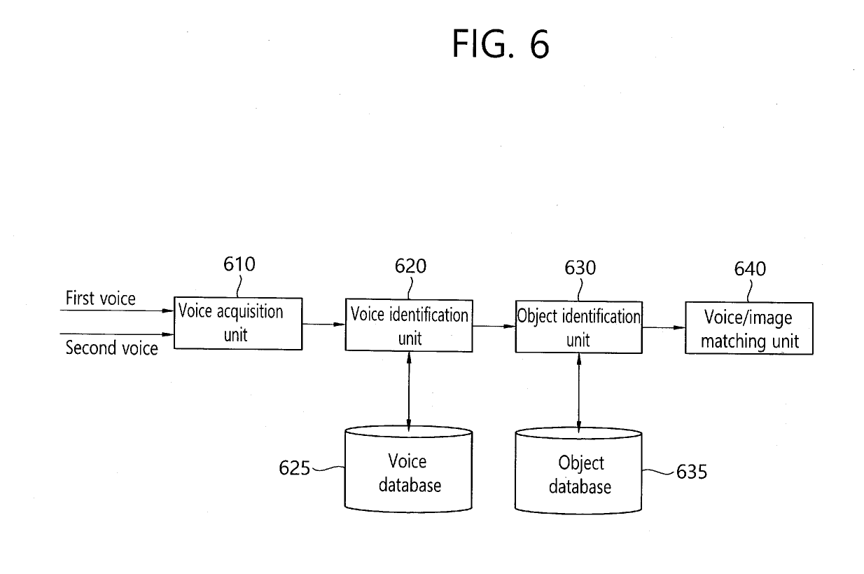

FIG. 6 is a block diagram illustrating a configuration that the voice-recognized text data is inserted in an image with being associated with a subject. As shown in FIG. 6, the configuration for image insertion according to an embodiment of the present invention may include a voice acquisition unit 610, a voice identification unit 620, an object identification unit 630 and a voice/image matching unit 640.

Referring to FIG. 6, the voice acquisition unit 610 may obtain a first voice data and a second voice data which are distinguished through the voice separation unit. And, the voice acquisition unit 610 provides the distinguished voices to the voice identification unit 620.

The voice identification unit 620 compares the voice characteristic like the frequency of the separated voice with the voice characteristic information stored in the voice database 625, and identifies the voice of a specific subject and/or the voice of a photographer. The voice identification unit 620 receives the information on the separated voice data and utilizes it for voice recognition.

Basically, the voice analysis in the voice identification unit 620 is based on the frequency analysis. This may also be referred to spectrum analysis since a frequency spectrum is obtained by the frequency analysis of the obtained voice data. In the case that the voice is heard as speech sound, there is no influence on phase spectrum. Accordingly, the power spectrum indicating only amplitude may be used. The voice waveform represents substantially uniform property (called as quasi-stationary) in relatively short (a few ten ms to a few hundred ms) duration, and the property changes in longer time duration.

Accordingly, it is preferable that the voice identification unit 620 performs spectrum analysis of a short time, which may be regarded as quasi-stationary in the spectrum analysis of the voice signal. The frequency analysis method may utilize filter bank method that a center frequency outputs a plurality of different band filter in addition to the analysis based on Fourier transform.

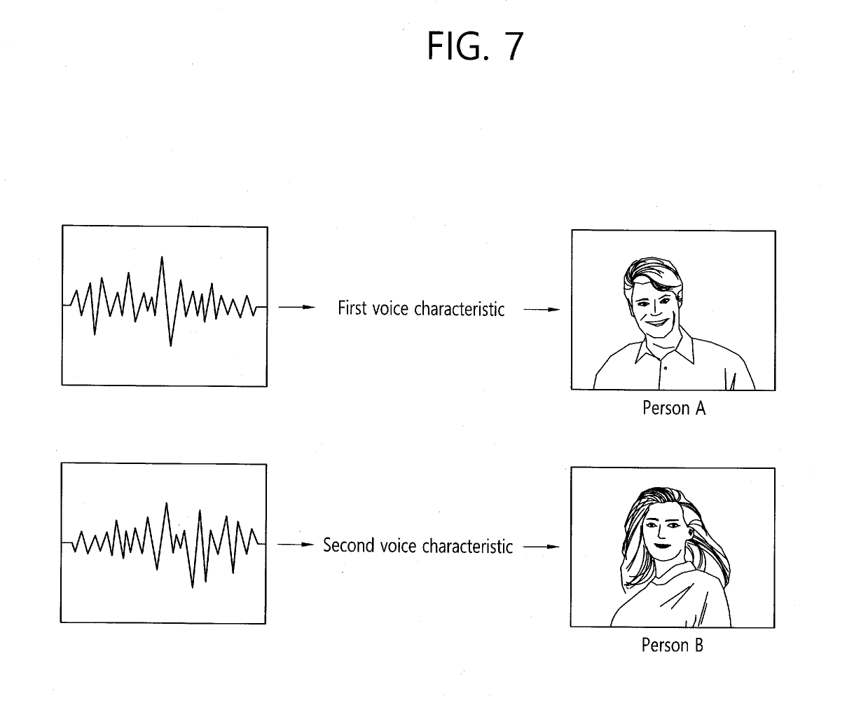

The process of voice characteristic analysis in the voice identification unit 620 and the process of matching the analyzed result with a specific person are described in more detail with reference to FIG. 7.

FIG. 7 is a schematic diagram for describing a method for matching voice data having different voice characteristic to a specific subject in an image.

Referring to FIG. 7, the first voice data obtained from the voice identification unit may have a first voice characteristic and the second voice data may obtain a second voice characteristic. And, it is identified that the first voice characteristic corresponds to a person “A” stored in the voice database and the second voice characteristic corresponds to a person “B” stored in the voice database.

That is, in the voice database, basically, the voice characteristic information on a user of the apparatus may be stored. It is highly probable that the user of the apparatus is a photographer, and it is preferable that the voice characteristic information on the photographer is previously stored. In addition, in the voice database, the voice information on the neighbors of the user of the apparatus, which is frequently exposed to photographs taken by the user terminal may be stored. This may be stored in advance by using a user configuration interface in relation to a voice characteristic record of a camera application. Otherwise, after the voice is input with taking a photograph simultaneously according to the photographing method according to an embodiment of the present invention, when there is no result matched to the previously stored voice characteristic, the person information for the input voice is inputted, and accordingly, the person information corresponding to the voice characteristic may be stored. In this case, the indication information is included, which represents that the person information is information associated with the photographer. This may be provided with flag format, and “0” may represent a photographer, “1” may represent a person except the photographer (including subject). Otherwise, “0” may represent a photographer, “1” may represent the case that there is a specific corresponding person except the photographer, “2” may represent the case that there is not specific corresponding person but gender and/or age of the person is distinguishable, and “3” may represent the case that it is unable to identify person-related information. The person information may include image information on a specific person and may be used for matching the person with an object identified in the object identification unit. The word “person information” is a word contrasted with object information.

The voice database including such voice characteristic information and the corresponding person information thereof may be implemented as a local storage in the apparatus, or may also be implemented as a large capacity database interlinked with the server. Particularly, in the large capacity database interlinked with the server, the voice identification unit of the apparatus may extract the voice characteristic information and provide it to the server, and obtain the information in relation to the corresponding person in the server, and accordingly, may obtain the person information that corresponds to the voice characteristic. In the voice database, as the apparatus is continually used for taking a photograph, more voice characteristic information and the corresponding person information thereof may be piled. In addition, since the server may obtain the voice characteristic information and the corresponding person information thereof from a plurality of terminals, the server may obtain a large amount of voice characteristic information increasing geometrically and the person information corresponding thereof.

The voice data having the voice characteristic that corresponds to the voice characteristic for a previously stored specific person may be identified as a specific person, and may be provided with identification information on the voice data. This is the identification information associated with the specific person, and the information distinguished from the association information with the text described above.

Additionally, the voice identification unit includes the algorithm that distinguishes the input voice is that of a man or a woman, and the age range, in the case that there is no voice data matched to a specific person. This may be implemented by the method of utilizing a basic register of a man and a woman, and a basic resister of a specific age range. In addition, according to the algorithm for voice recognition in the voice identification unit and/or the server interlinked with the voice identification unit, the voice characteristic information piled in real time and the corresponding person information thereof (including the gender of the corresponding person and age information) are generated as a training data set, and machine learned. This is trained based on deep learning algorithm. Through such a process, the person information that the voice identification unit provides to the voice data may further include the gender of the corresponding voice and the age information thereof.

Returning to FIG. 6 again, when the voice identification unit 620 obtains the person information on specific voice data, the object identification unit 630 performs an analysis for the objects placed in the image using the object recognition algorithm. Basically, the object identification unit 630 intensively analyzes the part in relation to the person among the subjects placed in the image. The object identification unit 630 is interlinked with an object database 635. The object database 635 may also be implemented as a local storage in the apparatus and/or a large capacity database interlinked with the server.

The object database 635 may store the image information associated with a specific person and a specific subject and the corresponding person and object information. For example, the object database 635 may store the image (including a face, an arm, a leg, etc. and the other part excluding the face) of person “A” and the information associated with person “A”, for example, a gender, an age, an address, and the like matched to person “A”. That is, the object database 635 performs an object analysis on the subject included in the obtained image and compares it with the image included in the object database, and when there is a corresponding image, the object database 635 may obtain the corresponding person information. Alternatively, for a thing object, the object database 635 may have an image of the thing object (e.g., a building, a bridge, etc.), which is not a person, and the corresponding information. Such information may be continuously accumulated as the photographing continues.

The object database 635 and the voice database 625 may be interlinked. That is, the person information on the same person (image information, voice information and/or person/object information) may be shared and accumulated together. Otherwise, the object database 635 and the voice database 625 may be implemented as a single database.

The voice/image matching unit 640 obtains person and/or object information on the subject from the object identification unit 630, and obtains the obtained person information through identifying the voice data from the voice identification unit 620, and compares both of the information. As a result of the comparison, in the case that both information is determined as that of the same person, the voice/image matching unit 640 associates the voice data with the corresponding subject.

As a result of the association, the text associated with specific voice data is obtained based on text-voice association information (first association information) from the text transform unit, and the obtained text may be disposed around the associated subject (using second association information). That is, when the first voice data is identified as person “A” and the first subject in the image is identified as person “A”, the both are associated, and then, the first text obtained from the first voice data is disposed around the first subject. When the second voice data is identified as person “B”, and the second subject in the image is identified as person “B”, the both are associated, and then, the second text obtained from the second voice data is disposed around the second subject. As such, when a user input is detected for the text disposed around the subject, the voice data associated with the corresponding text is loaded and played back. For example, when the second text around the second subject is clicked, the second voice data is outputted, and the contents that the second subject said when the photograph was taken may be played back.

Additionally, in the case that the person information obtained from the voice data is not clearly identified as a specific person, but identified as a teen age woman, and the person information through the object analysis is identified as a teen age woman, the corresponding voice data is matched to the subject of a teen age woman, and the text transformed from the corresponding voice data may be placed around the subject of a teen age woman. As such, the information on person's age and gender obtained from the voice data may be matched to the subject information according to the object analysis optimally. The age/gender and the corresponding voice tone, and the like may also be analyzed by the object analysis.

In addition, in the case that it is identified as the voice data of the photographer, when the photographer is shown as a specific subject in the photograph, it is matched to the corresponding subject and placed around the subject. In the case that the photograph is not shown in the photograph, the text may be placed with being associated with the subject according to the text process associated with the photographer or may be placed on the predetermined position without regard to the subject.

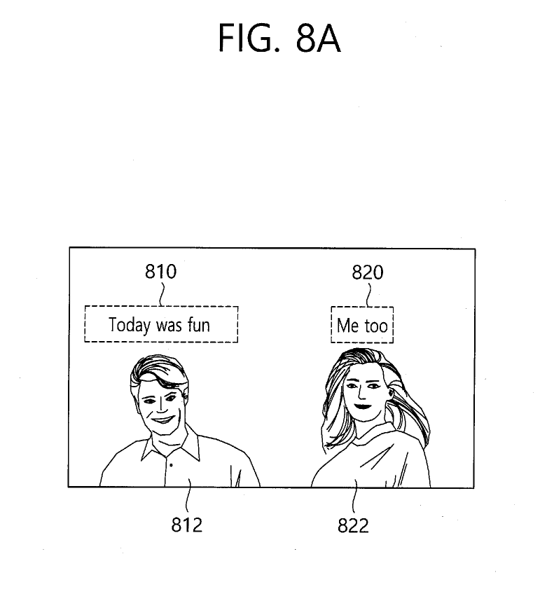

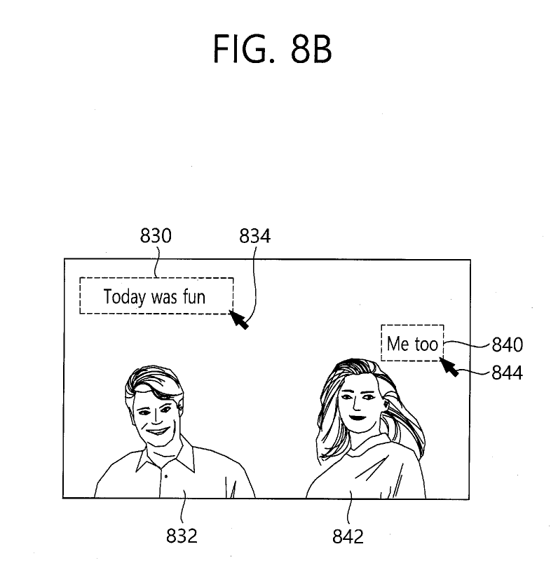

FIGS. 8a and 8b are schematic diagram for describing the process that the text is disposed on an arbitrary position in the image according to the automatic mode and the manual mode.

Referring to FIG. 8a, the apparatus may dispose the text around the associated subject using the automatic mode. Since a first text 810 is associated with a first subject 812, the first text 810 is automatically disposed around the first subject 812. Since a second text 820 is associated with a second subject 822, the second text 820 is automatically disposed around the second subject 822. At this time, the neighboring area in which the text is disposed may be predetermined to a top or a bottom of the subject, and/or a left or a right of the subject by a user configuration. In addition, other objects around the subject are analyzed in the object identification unit, and it may be disposed on the optimal position with the relationship with the analyzed other objects. That is, even in the case that it is configured to be disposed on the top of the subject, when other thing object (e.g., a building, the sun, etc. is placed) on the top of the subject, the text may be disposed at a left or a right side by avoiding the corresponding thing object.

Referring to FIG. 8b, a first text 830 and a second text 840, which are separated with each other, are disposed on a specific position in the image manually through a user input 834 or 844. These are not necessarily disposed with being associated with a subject 832 or 842 around, but the position may be arbitrarily determined by a user.

According to another embodiment of the present invention, according to the manual mode, a user may generate the position relation between a text disposition area and the subject and/or the position relation between a text disposition area and an object around the subject as a training data set. Accordingly, the apparatus (or server) may implement that the learning of an optimized insertion position in the automatic mode may be performed through deep learning algorithm. Accordingly, the text insertion position in the automatic mode may be placed in accordance with the preference of a user (or a plurality of members accessing to the server).

FIG. 9 is a block diagram particularly illustrating a configuration for determining an insertion position according to a meaning of a recognized text. As shown in FIG. 9, the configuration of determining an insertion position according to an embodiment of the present invention may include a meaning analyzing unit 910 and an insertion position determination unit 920. These may be constituent elements included in the image composite unit shown in FIG. 2.

Referring to FIG. 9, the meaning analyzing unit 910 obtains the text information recognized from the text transform unit, and performs a meaning analysis based on the word stored in the word database 912.

Further, the analyzed meaning information is provided to the insertion position determination unit 920. The insertion position determination unit 920 determines an insertion position based on the meaning of the text. That is, the insertion position determination unit 920 may store the position relation according to a specific meaning in advance, and properly determines an insertion position that corresponds to an input text.

The insertion position determination unit 920 disposes the text having the meaning in relation to a person around a person. For example, it is preferable that a person's name such as “Young-Hee” and “Chul-Soo” and the words representing a specific part of a person such as “arm”, “leg” and “head” are disposed around of the person (particularly, on the corresponding part).

In addition, the text having the meaning associated with a relation between persons is disposed between person subjects. For example, the wording such as “I love you”, “I like you”, “I hate you” and “friendly” may be disposed between two or more persons or on the center thereof.

Additionally, it may be configured that the text of another specific meaning is disposed on the center, left or right side, outermost of top or bottom without considering a disposition of the subject.

Particularly, the contents which are meaning-analyzed may be inserted within an image with being interlinked with a sticker that decorates the subject and the photograph image. For example, the text like “I love you” may be indicated in the image with being interlinked with the heart-shaped sticker “ [symbol] ”. That is, the text having a specific meaning and the corresponding sticker are previously stored, and the sticker according to the result of the meaning analysis of the text may be indicated in the image together with the text.

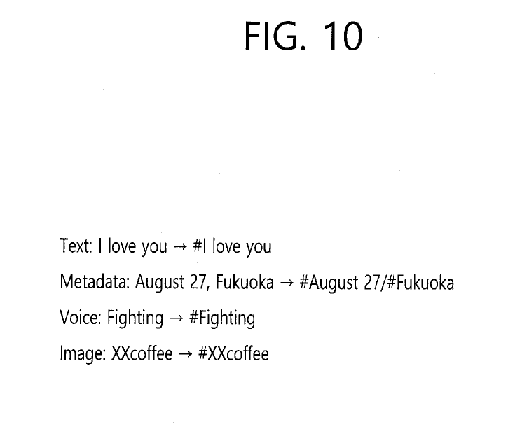

FIG. 10 is a schematic diagram for describing automatic generation of a hash tag.

Referring to FIG. 10, the apparatus may transform the metadata, the voice file and the text in relation to a photograph into a hash tag automatically. In common case, a plurality of commercial contents is searched in an SNS platform since indiscriminate photograph registration and hash tag are used, and accordingly, there is a disadvantage that an accuracy of search is very low. Accordingly, the photograph sharing apparatus according to an embodiment of the present invention may transform metadata of a photograph, for example, the data and time of photograph and the photographing place information, into hash tag. In addition, the text and voice information is also transformed to hash tag automatically.

According to an embodiment of the present invention, the apparatus may extract a specific object in the image, and transform the corresponding object to hash tag. For example, in the case that “XX café” is shown in a signboard attached to a specific building in the image, the “XX café” is extracted through the object extraction algorithm in the object identification unit, and based on it, the hash tag “#XX café” may be automatically generated.

In addition, a tag is generated by combining the metadata such as the data and time of photograph, the photographing place, the photographing device, and the like, the text, the voice and/or the object information in the image, and the accuracy of search may be improved.

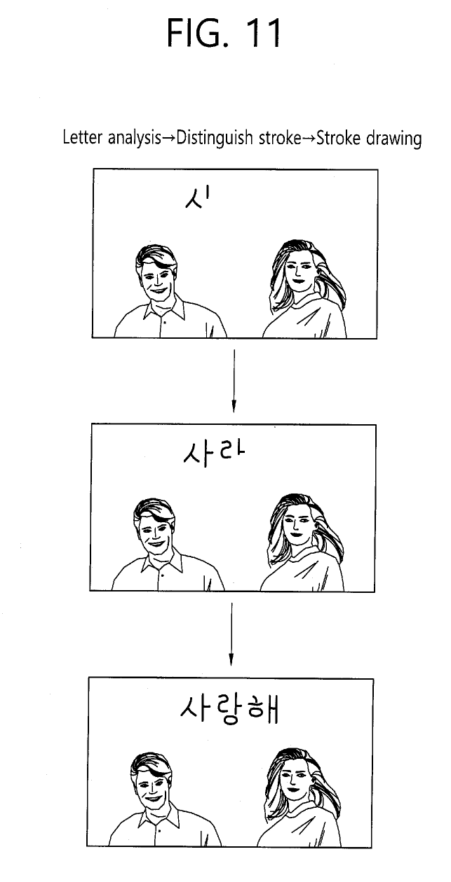

FIG. 11 is a schematic diagram for describing an emotional text drawing.

Referring to FIG. 11, when outputting a text on an image, the photograph sharing apparatus according to an embodiment of the present invention may playback the text with dictation format. For this, the output order among a plurality of letters that construct the text, the output order among a plurality of strokes included in each of the plurality of letters and the information on drawing from the output start point to the output end point of each of the plurality of strokes are stored, and based on the corresponding information, the first letter to the last letter of the text may be played back with the dictation format. That is, it is preferable to determine an order that the letters are recognized from a left of the text, and the letters are output from the left. The expression “I love you” is outputted in the order that “I”, “love” and then, “you”. In the case of Korean word “ [symbol] ”, each stroke of the word is written based on Korean letter stroke order information. In the case of “ [symbol] ”, “ [symbol] ” and “ [symbol] ” are written but each of the strokes “/”, “\”, “|” and “-” is outputted in the order. In addition, each stroke is drawn from a top left to a bottom right. Such an emotional drawing may be implemented through a plurality of frames like an animation such that the corresponding part is drawn. That is, this may be played back in a video image format like gif file.

However, such an emotional drawing is not always executed, but may be changed according to a user configuration.

According to another embodiment of the present invention, an image is outputted first, and then a text is outputted thereon at one time, and accordingly, the file in which the image and the text are composed may be played back.

FIG. 12 is a block diagram illustrating a system for storing data based on block-chain according to an embodiment of the present invention. The system of storing data based on block-chain according to an embodiment of the present invention includes a user terminal 1210, an authentication information issuance server 1220, a blockchain-based data management server 1230 and a block chain data possession server 1240.

Referring to FIG. 12, as it is well known, the block-chain is a technique that safely records and stores transactions performed on a network communication. The transactions are recorded in each block, and form a chain as time goes on. The chains are stored in distribution manner on P2P network, and form block-chain network.

Referring to FIG. 12, a terminal 1210 generates a public key and a private key, and transmits the blockchain-based personal information for issuing authentication information including the public key and the identification information on the user required for issuing the block-chain based authentication information to the authentication information issuance server 1220. For this, the terminal 1210 may include a key generation engine and an encoding/decoding engine. The user information for issuing the blockchain-based authentication information may include at least a part of a user name, a user registration number, a user phone number and a user email.

Before generating the public key and the private key, the terminal 1210 may perform the process of checking whether the user using the corresponding terminal 1210 registers the identification information on the user in the authentication information issuance server 1220. The terminal 1210 transmits the user information for issuing the block-chain based authentication information to the authentication information issuance server 1220, and requests an issuance of the blockchain-based authentication information.

The authentication information issuance server 1220 matches the user information for issuing the blockchain-based authentication information to a user identification information database for each account (not shown). In the case that there is matched information, the authentication information issuance server 1220 generates a key generation guidance signal that guides the generation of the public key and the private key and sends it to the terminal 1210. In the case that there is no matched information, the authentication information issuance server 1220 may transmit a message representing that it is not available to issue authentication information.

Particularly, when the authentication information issuance server 1220 obtains identification information on a specific user as the issuance request for the authentication information, the authentication information issuance server 1220 checks whether the identification information on the specific user is registered. As a result of the check, in the case that the identification information on the specific user is registered, the authentication information issuance server 1220 makes the terminal generate the public key and the private key of the specific user.

When the key generation guidance signal is received from the authentication information issuance server 1220, the terminal 1210 generates the public key and the private key by executing the key generation engine (not shown). In this case, it is preferable that the terminal 1210 controls such that the public key and the private key are generated in the state of blocking a network, and blocks the external leakage each key that may occur in advance.

The terminal 1210 operates the encoding/decoding engine (not shown), and encrypts the private key based on the password and/or the image that the user designates, and then stores it in a local storage (not shown). Accordingly, even in the case that the private key of the user is leaked, the information can be read only in the case that the password and/or the image that the user designates are known, and accordingly, security may be enforced. When the encoded private key is stored, the terminal 1210 outputs alarm for connecting a network again, and the user may connect the network.

The authentication information issuance server 1220 may includes an interlinked database. The database of the authentication information issuance server 1220 stores the identification information on the user that operates the terminal 1210. In addition, the database includes a user identification information database for each member in which the identification information on the user which is the same as the user information for issuing the block-chain based authentication information.

The authentication information issuance server 1220 receives the public key and the user information for issuing the blockchain-based authentication information from the terminal 1210, and hash-operates the user information for issuing the blockchain-based authentication information, and processes it into user identification hash information.

The authentication information issuance server 1220 is a server that collects designated user identification information corresponding to identification information on the previously designated user among the identification information on users constructing the user identification hash information, the public key and the user information for issuing the blockchain-based authentication information, and processes it into a transaction generation request signal, and then transmits it to the blockchain-based data management server 1230.

The blockchain-based data management server 1230 may perform operations of transaction generation and transmission according to whether the user identification information is registered. Here, the designated user identification information may include a phone number of the user. For this, the authentication information issuance server 1220 may include a hash-process engine (not shown). The hash-process engine performs the function of hash-operating the user information for issuing the blockchain-based authentication information, and processing it into user identification hash information.

In the case that the user information is in registered state when the identification information is obtained according to the issuance request for the authentication information from the terminal 1210, the blockchain-based data management server 1230 generates the public key of the user and the hash value of the identification information or the transaction having the processed value as an output, transmits it to block-chain or supports to transmit it, and obtains a transaction ID indicating the position information in which the transaction is recorded on the block-chain. The transmission for the block-chain may include a transmission for the block-chain data possession server 1240. For this, the blockchain-based data management server 1230 may check the identification information on a specific user in the database. The blockchain-based data management server 1230 may obtain and store the transaction ID indicating the position information recorded on the block-chain, hash-operate the user identification hash information and the transaction ID, and process it into user verification hash information.

The blockchain-based data management server 1230 that performs such a function may be a server of a company that requires performing an authentication when using a service.

Each of the block-chain data possession servers 1240 includes a respective member. This may be a component corresponding to terminals 295-1 to 295-N shown in FIG. 2. Each of the block-chain data possession servers 1240 stores the transaction corresponding to the user information having block-chain, and when a new transaction is received, the transaction information is recorded after authentication is performed, and simultaneously, transmits the transaction corresponding to the image, the text, the voice and/or the metadata (or the related link information, hereinafter, referred to as ‘image/text packaging information’) according to an embodiment of the present invention to the next the block-chain data possession servers 1240.

Particularly, the transmission of the transaction corresponding to the image/text packaging information is promised by a protocol, when a new transaction is generated, this is transmitted to multiple nodes (e.g., 8 nodes) in which a single node (here, this is referred to as the block-chain data possession servers 1240) is designated, and through pyramid type transmission of repeatedly transmitting the multiple nodes that receive transaction information for paying the Bit Coin (it is also fine to use other encrypted money like Ethereum, etc.), transmitted to all block-chain data possession servers 1240, and then completed. As such, all of the transactions recorded in the block-chain are impossible to forge afterward.

As described above, the system that stores data based on block-chain according to an embodiment of the present invention records the image/text packing information in the block-chain data possession servers 1240, which are block-chain forms. In addition, the system may record the transmission/reception list transmitted and received between terminals, the search list and/or the related payment list information in the block-chain data possession servers 1240.

The blockchain-based data management server 1230 performs an information management role including addition, move and deletion for the information recorded in the block-chain data possession servers 1240, and processes the information management role based on approval of the block-chain data possession servers 1240.

The image/text packaging information recorded in the block-chain data possession servers 1240 may include an image, a text, voice data (or link information on the voice data), and metadata.

According to an embodiment of the present invention, when there is a request of recording the image/text packing information, the terminal 1210 generates the public key and the private key through the authentication information issuance server 1220 and transmits it to the blockchain-based data management server 1230. After checking whether the public key and the private key received from the terminal 1210 is registered, the blockchain-based data management server 1230 generates the transaction for recording information by processing the image/text packaging information that the terminal 1210 requests into hash value, and forwards the generated transaction to the block-chain data possession servers 1240 to be approved.

FIG. 13 is a flowchart for describing a method for storing data based on block-chain according to an embodiment of the present invention.

Referring to FIG. 13, in the description above, the terminal requests the photograph information (image/text packaging information) to the blockchain-based data management server (step, S1310). And, after checking whether the public key and the private key received from the terminal is registered, the blockchain-based data management server generates the transaction block for recording information by processing the information into hash value (step, S1320), and forwards the generated transaction block to the block-chain data possession servers (step, S1330). In this case, the transmission of the transaction corresponding to the image/text packaging information is promised by a protocol, when a new transaction is generated, this is transmitted to multiple nodes in which a single node is designated, and through pyramid type transmission of repeatedly transmitting the multiple nodes that receive transaction information for paying the Bit Coin (it is also fine to use other encrypted money like Ethereum, etc.), transmitted to all block-chain data possession servers. In the case that all of the block-chain data possession servers approve the transaction block (step, S1340) and add the transaction block (step, S1350), the record of the photograph information requested from the terminal is completed (step, S1360).

According to an embodiment of the present invention, the encrypted money like Bit Coin may be generated together with the generation of the transaction associated with the photograph information. Alternatively, the encrypted money may be generated by sharing request by other users for a specific transaction. That is, the encrypted money may be obtained according to obtaining fame according to the information sharing. In addition, the platform based on the block-chain includes the shared platform like SNS. That is, the system to which the photograph sharing method is applied according to an embodiment of the present invention may be a system operated in open block-chain scheme described above in the form like FACEBOOK and INSTAGRAM.

Additionally, according to an embodiment of the present invention, in addition to the open block-chain scheme described above, closed block-chain scheme may be applied to the photograph sharing system according to an embodiment of the present invention.

The system or the apparatus described herein may be implemented using hardware components, software components and/or a combination of hardware and software components. For example, the system, apparatus and constituent elements described in the embodiments may be implemented using one or more general-purpose or special purpose computers, such as, for example, a processor, a controller and an arithmetic logic unit (ALU), a digital signal processor, a microcomputer, a field programmable array (FPA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For the purpose of understanding, the description of a processing device is used as singular; however, those skilled in the art will appreciated that a processing device may include multiple processing elements and multiple types of processing elements. For example, a processing device may include multiple processors or a processor and a controller. In addition, different processing configurations are also available, such as parallel processors.

The software may include a computer program, a piece of code, an instruction, or some combination thereof, for independently or collectively instructing or configuring the processing device to operate as desired. Software and/or data may be embodied permanently or temporarily in any type of machine, component, physical equipment, virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The method according to the embodiments may be recorded in non-transitory computer-readable media including program instructions to implement various operations embodied by a computer. The computer-readable media may also include, alone or in combination with the program instructions, data files, data structures, and the like. The program instructions stored in the media may be those specially designed and constructed for the purposes, or they may be of the kind well-known and available to those having skill in the computer software arts. Examples of computer-readable media include magnetic media such as hard disks, floppy disks, and magnetic tape; optical media such as CD-ROM disks and DVD; magneto-optical media such as floptical disks; and hardware devices that are specially devised to store and perform program instructions, such as ROM, RAM, flash memory, and the like.

Examples of program instructions include both machine code, such as produced by a compiler, and files containing higher level code that may be executed by the computer using an interpreter. The above-described hardware devices may be to act as one or more software modules in order to perform the operations of the above-described embodiments, and so does the opposite case.

The foregoing embodiments have been provided by limited embodiments and drawings, but various alteration and modification are available to those skilled in the art from the description above. For example, a proper result may be attained even in the case that the techniques described above are performed in different order from the described method, and/or the system, structure, device, circuit, and the like described above are coupled or combined in different form from the described method, or substituted by other components or equivalents.

Therefore, other implementations, other embodiments and the equivalent to the claims are also intended to be included within the scope of the claims.

According to the photograph sharing method, apparatus and system based on voice recognition, information is added to a photograph through voice recognition in real time, and emotion and vitality are inserted, and there is an effect that the user using it may feel fun factors and convenience factors together.

What is claimed is:

1. A method for sharing a photograph based on voice recognition, the method comprising:
obtaining an image for a photograph taken using a camera;
obtaining voice data associated with the obtained image;
generating a text by recognizing the obtained voice data;
associating and storing the obtained image, the obtained voice data and the generated text; and
outputting the store image together with at least one of the stored voice data and the stored text.

2. The method for sharing a photograph based on voice recognition of claim 1, further comprising storing the obtained image, the obtained voice data and the generated text in a server,
wherein the data stored in the server is searched based on at least one of the voice data and the text.

3. The method for sharing a photograph based on voice recognition of claim 1, wherein associating and storing the obtained image, the obtained voice data and the generated text comprises:
inserting the text into the image,
wherein the text is inserted to a first layer which is identical to a layer that the image inserted in or inserted into a second layer which is different from the layer that the image is inserted in.

4. The method for sharing a photograph based on voice recognition of claim 3, wherein the insertion of the text into the first layer comprises:
inserting the text into an arbitrary area on the image;
identifying a first area in which the text is inserted; and
generating the image in which the text is inserted as an image file, wherein the image file is associated with identification information on the first area.

5. The method for sharing a photograph based on voice recognition of claim 1, wherein the stored voice data is stored by being packaged with the image and the text.

6. The method for sharing a photograph based on voice recognition of claim 1, wherein the stored voice data is stored in a separate storage, and wherein the image and the text are packaged with link information on the storage of the voice data.

7. The method for sharing a photograph based on voice recognition of claim 1, wherein the associated voice data includes at least one of voice data associated with a photographer placed outside of a first space in relation to taking the photograph and voice data associated with a subject placed in the first space.

8. The method for sharing a photograph based on voice recognition of claim 1, wherein associating and storing the obtained image, the obtained voice data and the generated text comprises:
analyzing voice of the obtained voice data, wherein the voice data includes a first voice data having a first voice characteristic and a second voice data having a second voice characteristic, and separating into the first voice data and the second voice data.

9. The method for sharing a photograph based on voice recognition of claim 8, the generating a text by recognizing the obtained voice data comprising:
generating a first text by recognizing the separated first voice data; and
generating a second text by recognizing the separated second voice data, wherein the first text and the second text are associated with the first voice data and the second voice data, respectively.

10. The method for sharing a photograph based on voice recognition of claim 9, wherein associating and storing the obtained image, the obtained voice data and the generated text comprises:
recognizing each of a first subject and a second subject included in the image by applying object recognition algorithm for the image;
associating the first subject included in the image with the first text; and
associating the second subject included in the image with the second text.

11. The method for sharing a photograph based on voice recognition of claim 1, wherein associating and storing the obtained image, the obtained voice data and the generated text comprises:
identifying the voice data by comparing voice characteristic information associated with the obtained voice data with voice characteristic information previously stored in a voice database.

12. The method for sharing a photograph based on voice recognition of claim 1, wherein a position of the text is determined by at least one of:
a first mode in which the text is automatically disposed in at least one position of a previously designated position and a position according to an image analysis result, among the area of the image; and
a second mode in which the text is disposed according to a user input.

13. The method for sharing a photograph based on voice recognition of claim 12, further comprising:
analyzing a meaning of the text,
wherein the text is automatically disposed in an area corresponding to meaning analysis result when operating in the first mode.

14. The method for sharing a photograph based on voice recognition of claim 1, when the stored image is registered in Social Network Service (SNS), wherein the stored image is registered by generating hash tag automatically based on at least one of the image, the voice data, the text and metadata associated with the image.

15. The method for sharing a photograph based on voice recognition of claim 1, in outputting the text, based on an output order among a plurality of letters that construct the text, an output order among a plurality of strokes included in each of the plurality of letters and information on drawing from an output start point to an output end point of each of the plurality of strokes,
the text is outputted with a dictation format from a first letter to a last letter of the text.

16. The method for sharing a photograph based on voice recognition of claim 1, wherein associating and storing the obtained image, the obtained voice data and the generated text comprises:
storing the information associated with the obtained image, the obtained voice data and the generated text in block-chain.

17. An apparatus for sharing a photograph based on voice recognition, the apparatus comprising:
an information acquisition unit for obtaining an image for a photograph taken using a camera, and obtaining voice data associated with the obtained image;
a text transform unit for generating a text by recognizing the obtained voice data;
a data storage unit for associating and storing the obtained image, the obtained voice data and the generated text; and
a data output unit for outputting the store image together with at least one of the stored voice data and the stored text.

18. A system for sharing a photograph based on voice recognition, the system comprising:
a user terminal for obtaining an image associated with a photograph and voice data associated with the image, generating a text by recognizing the obtained voice data, associating and storing the image, the voice data and the text, and requesting to record the stored image, the voice data and the text in block-chain format;
a plurality of block-chain possession servers for recording the image, the voice data and the text generated in the user terminal in the block-chain format; and
a blockchain-based data management server for processing a block-chain management role including at least one of addition, move and deletion for block-chain information recorded in the block-chain data possession servers based on an approval of the block-chain data possession servers.

19. The system for sharing a photograph based on voice recognition of claim 18, wherein the blockchain-based data management server records at least one of download information and payment information in relation to the image, the voice data and the text, which are exchanged between a first user terminal and a second user terminal, in the block-chain data possession servers.

20. The system for sharing a photograph based on voice recognition of claim 18, when there is a request of recording the block-chain of the image, the voice data and the text, wherein the user terminal generates a public key and a private key through an authentication information issuance server and transmits it to the blockchain-based data management server,
after checking whether the public key and the private key received from the user terminal is registered, the blockchain-based data management server generates the transaction for recording information by processing the image, the voice data and the text requested by the user terminal into hash value, and forwards the generated transaction to the block-chain data possession servers to be approved.
